(19) United States
(12) Patent Application Publication
(10) Pub. No.: US 2022/0212968 A1
(43) Pub. Date: Jul. 7, 2022

(54) TRICKLING FILTER SYSTEM

(71) Applicant: ENEXIO Water Technologies GmbH, Wettringen (DE)

(72) Inventors: Christian Henrich, Bergisch Gladbach (DE); Michael Müller, Bornheim (DE)

(73) Assignee: ENEXIO Water Technologies GmbH, Wettringen (DE)

(21) Appl. No.: 17/611,244

(22) PCT Filed: Feb. 19, 2020
(86) PCT No.: PCT/DE2020/000030

§ 371 Date: Nov. 15, 2021

(30) Foreign Application Priority Data
May 15, 2019 (DE) 10 2019 003 463.5

(51) Int. Cl. C02F 3/04

(52) U.S. Cl. CPC C02F 3/043

(57) ABSTRACT

A trickling filter system comprises at least three filler material containers arranged one next to the other such that one of the at least three filler material containers is in a middle position. Each of the at least three filler material containers comprises, a top defining an opening, a bottom comprising a water-permeable support structure, and a space between the top and the bottom comprising a filler material. A rotary sprinkler container configured to at least partially receive a rotary sprinkler and is positioned on top of the one of the at least three filler material containers in the middle position. The rotary sprinkler container is configured to enable rotation of the rotary sprinkler to sweep over at least a portion of the at least three filler material containers.

### CROSS REFERENCE TO RELATED APPLICATIONS

This application is a national stage application pursuant to 35 U.S.C. § 371 of International Application No. PCT/DE2020/000030, filed on Feb. 19, 2020, which claims priority to, and benefit of, German Patent Application No. 10 2019 003 463.5, filed May 15, 2019, the entire contents of which are hereby incorporated by reference.

### FIELD OF TECHNOLOGY

The present disclosure relates to an improved trickling filter system.

### BACKGROUND

The principle of trickling filter systems or trickling filters for treating wastewater is known. The wastewater is sprayed onto the top of a mass consisting of a large amount of filler material by means of a rotary sprinkler, wherein wastewater treatment takes places by the action of microorganisms. The purified wastewater is collected and drained in the lower region of the trickling filter. A number of variants are used as the filler material, for example volcanic rock, plastics bodies, etc. Trickling filter systems are used in a variety of designs to treat wastewater.

Furthermore, the use of standardized large-capacity tanks or containers is known in the field of wastewater treatment. For example, DE 37 21 981 A1 discloses a purification system for removing contaminants in the ground that can be easily accommodated in standardized large-capacity tanks which can be installed on-site without any problems and without significant constructional effort. DE 101 05 221 A1 discloses a method and a device for eliminating undesired water constituents, wherein the device can be accommodated in two 20′ containers. In this way, the entire system can be relocated with ease and can be used on a mobile basis in specially designated hot spots.

### BRIEF SUMMARY OF THE INVENTION

The object of the present invention is to provide an improved trickling filter system which allows for quick installation as well as simple and cost-effective operation.

This object is achieved according to the invention by a trickling filter system comprising at least three transportable containers (filler material containers) that are arranged one next to the other and that are filled with filler material, are open at the top, and have a wastewater-permeable support structure at the bottom for the filler material, and comprising a transportable container (rotary sprinkler container) that receives a rotary sprinkler and that is arranged on the middle filler material container, is at least partially open on both sides in order to allow for a rotation of the rotary sprinkler in order to sweep over at least part of the filler material containers, and has a wastewater-permeable support structure at the bottom.

According to the invention, a trickling filter system having a modular design is thus proposed. The invention is based on the fundamental concept that the filler material of the trickling filter and the rotary sprinkler of the trickling filter are to be accommodated in separate containers that can be arranged one next to the other and one on top of the other and readied for operation at the deployment site (in situ). In many fields of application, container solutions of this kind can be useful, for example in temporary military bases or refugee camps. Due to their mobility, quick installation, simple and cost-effective operation, and the simple replaceability of individual containers (container modules), a “containerized trickling filter system” of this kind can contribute to purifying wastewater in remote locations using robust technology.

The trickling filter system designed according to the invention comprises at least four containers, which include three filler material containers and one rotary sprinkler container. The three filler material containers are arranged one next to the other or fastened one to the other at the deployment site. The rotary sprinkler container is placed on the middle filler material container.

The filler material containers are open at the top and have a wastewater-permeable support structure at the bottom for the filler material. Any desired filler material that provides the corresponding growth surfaces may be used here. Since the filler material containers are open at the top, the wastewater distributed by the rotary sprinkler arrives onto the surface of the filler material located in the container. The support structure arranged at the bottom of the container keeps the filler material in the container, but allows for drainage of the treated wastewater.

Furthermore, the trickling filter system comprises a transportable container (rotary sprinkler container) that receives a rotary sprinkler and that is arranged and, if applicable, fastened on the middle filler material container at the deployment site of the trickling filter system. Said rotary sprinkler container is at least partially open on both sides, such that the rotary sprinkler arranged in the container can move sideways out of the container in order to rotate so as to sweep over at least part of the filler material containers arranged below. The rotary sprinkler container also has a wastewater-permeable support structure at the bottom, such that wastewater can be drained via the underside of the container. The rotary sprinkler container may also contain the entire drive thereof.

Preferably, the filler material containers and the rotary sprinkler container have the same dimensions, such that all container modules can be assembled in a simple and modular manner. The containers may be placed one next to the other and one on top of the other without being fastened to one another, or they are locked to one another by additional fastening means. Since all containers have the same dimensions, replacement is simple.

The filler material containers and the rotary sprinkler container are expediently rectangular in horizontal cross-section. They are box-shaped modules having two long and two short side walls. In order to construct the trickling filter system, the filler material containers are arranged with their long side walls one next to the other and the rotary sprinkler container is placed down on the middle filler material container in a corresponding manner with its longitudinal axis in parallel with the longitudinal axes of the filler material containers. The rotating rotary sprinkler can then sweep over substantially all filler material containers.

Preferably, the filler material containers and the rotary sprinkler container have the dimensions of conventional standardized large-capacity tanks. These dimensions may for example be those of known 40′ containers. Containers of this kind have a length of 12.2 m, a width of 2.4 m, and a height of 2.7 m or 2.4 m. Conventional containers of this kind can therefore be retrofitted in a simple manner with filler material containers and rotary sprinkler containers according to the invention.

A trickling filter system designed according to the invention may also have multiple layers of filler material containers arranged one on top of the other, for example two layers of filler material containers arranged one on top of the other, wherein the rotary sprinkler container is located on the middle filler material container of the upper layer. A preferred solution of the invention is characterized in that five filler material containers are arranged one next to the other, wherein, in a two-layer embodiment, five filler material containers are provided both in the bottom layer and in the top layer.

In order to enable problem-free transportation of the filler material containers and rotary sprinkler container, these preferably have a base that can be opened. The base may be closed for transportation and then opened at the operating location, such that wastewater can exit downward via the filler material arranged on the support structure. The containers may also comprise an openable cover that can also be opened at the operating location. Equally, the side walls of the rotary sprinkler container may be closed for transportation and then opened at the operating location in order to allow the rotary sprinkler to rotate.

After the wastewater has passed through the individual filler material containers, it arrives at the base of the system, where it is drained away. The lowest container layer is preferably arranged at a distance from the system base, such that the wastewater can exit the containers and collect on the base. The system preferably comprises an inclined base having a drainage channel for the wastewater, wherein the drainage channel may for example be arranged at the side or in the center of the base and the base has a corresponding inclination toward the drainage channel A suitable concrete slab may be used as the base, for example.

In order to enable unproblematic transportation of the rotary sprinkler container, same is in particular designed such that it receives all parts (rotary sprinkler arms, drive, wastewater inlet, etc.). For example, the rotary sprinkler preferably comprises two sprinkler arms that are arranged opposite one another and that can be accommodated in the rectangular container for transportation purposes. At the site, other arms can for example be mounted on the rotary sprinkler, such that a total of four or more arms, for example, are provided.

Furthermore, the wastewater inlet for the rotary sprinkler preferably extends inside the rotary sprinkler container from one side wall thereof to the rotary sprinkler axis. For example, the inlet may be located on one of the two short side walls of the container.

The invention also relates to a filler material container and to a rotary sprinkler container for use in a trickling filter system of the type described above.

### BRIEF DESCRIPTION OF THE DRAWINGS

The invention will be explained in detail below with reference to an exemplary embodiment in conjunction with the drawing. In the drawings:

FIG. 1 illustrates an elevational schematic view of an embodiment of a trickling filter system;

FIG. 2 illustrates the embodiment of FIG. 1 rotated by 90°;

FIG. 3 illustrates a schematic plan view of the embodiment of the trickling filter system from FIGS. 1 and 2;

FIG. 4 illustrates a schematic sectional view of an embodiment of a filler material container of the trickling filter system; and

FIG. 5 illustrates a schematic sectional view of an embodiment of a rotary sprinkler container of the trickling filter system.

### DETAILED DESCRIPTION OF THE INVENTION

The exemplary embodiment of a trickling filter system 1 shown in the figures has a modular design and is comprised of a total of 11 containers, which are arranged one above the other and one on top of the other at the deployment site. The figures show the trickling filter system 1 in the operationally ready state.

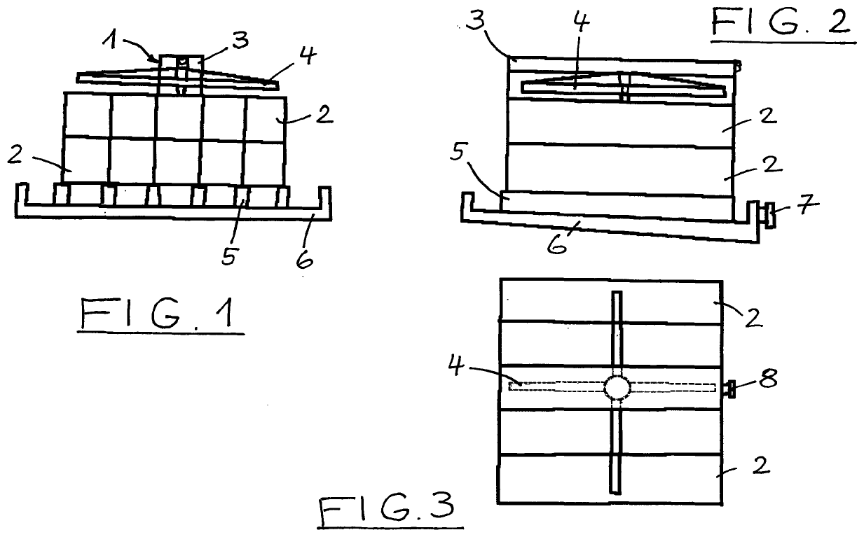

The system 1 comprises ten filler material containers 2, which are arranged one above the other in two layers of five containers in each case. The lower layer of filler material containers 2 is resting on a plurality of blocks 5, which are arranged on a base trough 6. FIG. 2 shows that the base trough 6 is inclined, such that the wastewater passing through the filler material containers 2 flows to a lateral drainage channel, where it is drained via an outlet 7.

Furthermore, the trickling filter system 1 comprises a rotary sprinkler container 3, which is the same size as the filler material containers 2 and is arranged on the middle filler material container 2 of the upper layer. Said rotary sprinkler container 3 comprises a conventional rotary sprinkler of a trickling filter, said rotary sprinkler having a central drive and two opposing sprinkler arms 4. All parts of the rotary sprinkler are accommodated in the rotary sprinkler container 3, wherein the arms 4 of the rotary sprinkler extend in parallel with the longitudinal axis of the rotary sprinkler container 3 when being transported. The containers are ones which have the dimensions of a standardized 40′ container as well as a rectangular plan. The plan view in FIG. 3 shows that the trickling filter system 1 has a square plan in the assembled state. Reference sign 8 denotes the wastewater inlet, which leads to the center of the rotary sprinkler, from which point the wastewater is guided into the rotary sprinkler arms 15 and from there is dispensed onto the top of the filler material containers 2.

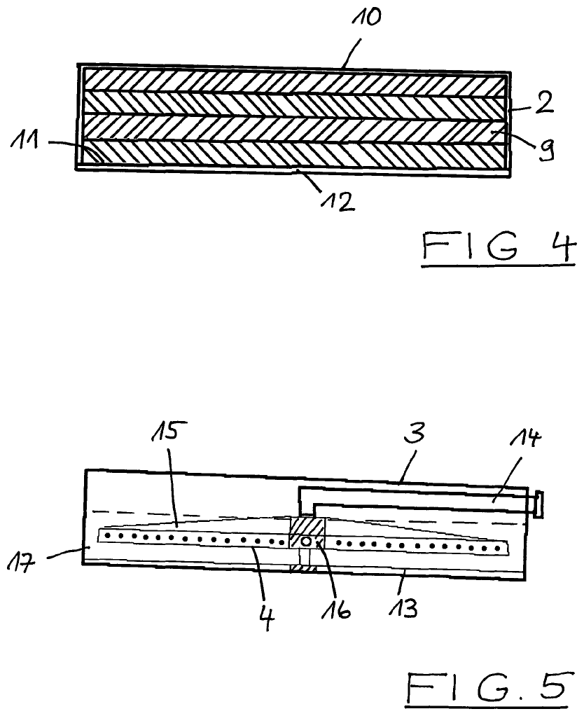

FIG. 4 is a schematic section through a filler material container 2. The container 2 comprises a removable base 12, above which a suitable support structure 11 for filler material 9 is arranged, wherein said support structure may be a suitable grid or rods or bars arranged in parallel, for example. Suitable filler material 9 is arranged in layers on the support structure 11, as shown in FIG. 4. The functioning of filler material 9 of this kind in a trickling filter is known and does not need to be explained in detail here. In addition, the container 2 has a removable cover 10.

The filler material container 2 may be filled with the filler material 9 at a suitable point and equipped there with the removable base 12 and the removable cover 10. It is then transported to the operating location and arranged accordingly, as shown in FIGS. 1 and 3, wherein the base 12 and cover 10 are removed.

FIG. 5 is a schematic section through a rotary sprinkler container 3. The container 3 comprises removable side walls 17 as well as a removable base 13 at least in the lower region. In this case, too, a suitable support structure is provided.

A rotary sprinkler 4 is accommodated in the container 3 and comprises two opposing sprinkler arms 15. A wastewater inlet pipe 14 extends from the short side of the container 3 to the center of the rotary sprinkler 4. From there, the wastewater supplied is distributed to the rotary sprinkler arms 15 and sprayed onto the tops of the filler material containers 2 arranged below when the rotary sprinkler is rotated. The drive of the rotary sprinkler 4 is denoted by 16.

The rotary sprinkler 4 may be provided with additional sprinkler arms at the operating location and, for example, comprise four sprinkler arms 15, as shown in FIG. 3. The need for additional arms is based on location-specific variables, such as volumetric flow rate, required spraying power, etc.

The trickling filter system 1 may be composed of multiple layers simply by stacking the containers 2, 3 one on top of the other. For example, a total filler material height of approx. 7.2 m may be achieved with three layers. For this purpose, 15 filler material containers 2 would be required, for example. By using ISO containers, which are designed for a load of approx. 27 t, no further measures are required for improving the statics during stacking.

1-11. (canceled)

12. A trickling filter system comprising;
at least three filler material containers arranged one next to the other such that one of the at least three filler material containers is in a middle position, wherein each of the at least three filler material containers comprises,
a top defining an opening,
a bottom comprising a water-permeable support structure, and
a space between the top and the bottom comprising a filler material;
a rotary sprinkler; and
a rotary sprinkler container configured to at least partially receive the rotary sprinkler and positioned on top of the one of the at least three filler material containers in the middle position,
wherein the rotary sprinkler container is configured to enable rotation of the rotary sprinkler to sweep over at least a portion of the at least three filler material containers.

13. The trickling filter system according to claim 12, wherein the at least three filler material containers and the rotary sprinkler container comprise same dimensions.

14. The trickling filter system according to claim 12, wherein a horizontal cross-section of the at least three filler material containers and the rotary sprinkler container comprises a rectangular shape.

15. The trickling filter system according to claim 12, wherein the at least three filler material containers and the rotary sprinkler container comprise dimensions of conventional standardized ISO large-capacity tanks.

16. The trickling filter system according to claim 12, further comprising additional filler material containers arranged on top of the at least three filling material containers.

17. The trickling filter system according to claim 12, further comprising at least five filler material containers arranged one next to another.

18. The trickling filter system according to claim 12, wherein the at least three filler material containers and the rotary sprinkler container comprise a base, and wherein the base defines an opening.

19. The trickling filter system according to claim 12, further comprising an inclined base configured to support the at least three filler material containers, wherein the inclined base comprises a drainage channel configured to convey treated wastewater.

20. The trickling filter system according to claim 12, wherein the rotary sprinkler further comprises a wastewater inlet, and wherein the wastewater inlet extends inside the rotary sprinkler container from one side wall along an axis of the rotary sprinkler.
